(19) United States
(12) Patent Application Publication
(10) Pub. No.: US 2026/0153064 A1
(43) Pub. Date: Jun. 4, 2026

(54) GAS TURBINE ENGINE WITH THIRD STREAM

(71) Applicants: General Electric Company, Evendale, OH (US); Safran Aircraft, Engines, Paris Cedex 15 (FR); Safran Nacelles, Gonfreville-l'Orcher (FR)

(72) Inventor: John Carl Glessner, Kings Mills, OH (US)

(21) Appl. No.: 19/126,677

(22) PCT Filed: Nov. 3, 2022
(86) PCT No.: PCT/US2022/048801

§ 371 Date: May 2, 2025

(51) Int. Cl. F02C 7/14; F02C 7/20; F02K 3/06

(52) U.S. Cl. CPC F02K 3/077; F02K 3/06; F02K 3/115

(57) ABSTRACT

A gas turbine engine including a turbomachine. The turbomachine including a compressor section, a combustion section, and a turbine section arranged in serial flow order. The turbomachine including an inlet duct defining an engine inlet, a fan duct defining a fan duct inlet, and a core duct defining a core duct inlet. The gas turbine engine including a fan cowl disposed circumferentially around the turbomachine and a heat exchanger defining a portion of the fan duct. At least a portion of the heat exchanger formed integrally with or coupled to the fan cowl.

### CROSS-REFERENCE TO RELATED APPLICATIONS

This application is a US National Stage application of PCT/US2022/048801, filed Nov. 3, 2022, which is hereby incorporated by reference in its entirety.

### FIELD

The present disclosure relates to a gas turbine engine, and more particularly to a gas turbine engine with a third stream.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a cross-sectional view of a gas turbine engine in accordance with another exemplary aspect of the present disclosure.

FIG. 3 is a cross-sectional view of a cowl assembly in accordance with an exemplary aspect of the present disclosure.

FIG. 4 is a cross-sectional view of a cowl assembly in accordance with another exemplary aspect of the present disclosure.

FIG. 5 is an aft looking forward view of a cowl assembly in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., —er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

A “third stream” as used herein means a non-primary air stream capable of increasing fluid energy to produce a minority of total propulsion system thrust. The third stream may generally receive inlet air (air from a ducted passage downstream of a primary fan) instead of freestream air (as the primary fan would). A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “coupled” and the like refer to both direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components.

For purposes of the description hereinafter, the term “longitudinal” and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the term “formed integrally” refers to a structure formed to be a continuous material or group of materials with no seams, connection joints, or the like. The unitary structures described herein may be formed through additive manufacturing to have the described structure, or alternatively through a casting process, etc.

The inventors of the present disclosure have found that for a three stream turbofan engine having a primary fan and a secondary fan, with the secondary fan being a ducted fan providing an airflow to a third stream of the engine, the amount of thrust generated by the primary fan may be reduced, with the secondary fan providing the difference through the third stream. Such a configuration may maintain a desired overall propulsive efficiently for the turbofan engine, or unexpectedly may in fact increase the over propulsive efficiency of the turbofan engine. Further, the present disclosure moves a radius of the third stream closer to a core engine of the turbofan engine, thus allowing for various external components that are typically mounted to the core engine to be mounted within an auxiliary space within the fan cowl.

Additionally, one or more heat exchangers may be disposed within the third stream and utilized to cool on or more fluids from the core engine with the air passing through the third stream. Dedicated structure may generally be used to form one or more ducts that define the third stream. These ducts may limit a cross-sectional area of the third stream, thus limiting the size of the one or more heat exchangers that may be disposed within. As such, the inventors of the present disclosure have found that by installing one or more heat exchangers to the fan cowl, the one or more heat exchangers may define a portion of a fan duct, eliminating the need for dedicated structure to define a portion of the third stream. Additionally, the installation of the heat exchanger on the fan cowl may allow for easier installation, repair, or maintenance of the one or more heat exchanger as at least a portion of the fan cowl may be removable during a maintenance operating condition of the gas turbine engine.

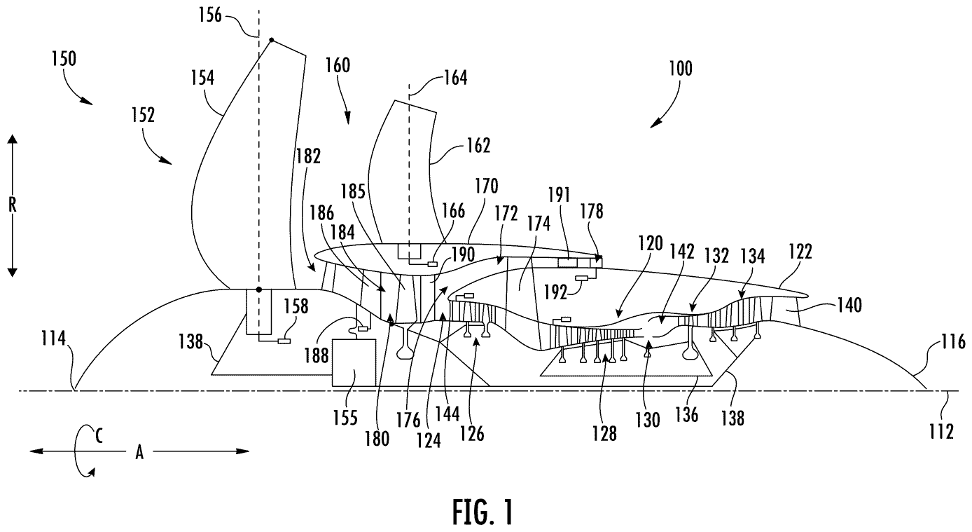

Referring now to FIG. 1, a schematic cross-sectional view of a gas turbine engine 100 is provided according to an example embodiment of the present disclosure. Particularly, FIG. 1 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 1 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustor 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. As will be appreciated, a distance from the base of each fan blade 154 to a tip of the respective fan blade 154 is referred to as a span of the respective fan blade 154. Each fan blade 154 defines a central blade axis 156. For this embodiment, each fan blade 154 of the fan 152 is rotatable about their respective central blade axis 156, e.g., in unison with one another. One or more actuators 158 are provided to facilitate such rotation and therefore may be used to change a pitch of the fan blades 154 about their respective central blades'axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades 185 arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween. As will be appreciated, a distance from the base of each fan blade of the ducted fan 184 to a tip of the respective fan blade is referred to as a span of the respective fan blade.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. The inlet duct 180 is wider than the core duct 142 along the radial direction R. The inlet duct 180 is also wider than the fan duct 172 along the radial direction R. The ducted fan 184 is positioned at least partially in the inlet duct 180.

Notably, for the embodiment depicted, the engine 100 includes one or more features to increase an efficiency of a third stream thrust (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, during one or more engine operating conditions. Further, by introducing a variability in the geometry of the inlet guide vanes 186 and the fan exhaust nozzle 178, the engine 100 may be capable of generating more efficient third stream thrust, across a relatively wide array of engine operating conditions, including takeoff and climb (where a maximum total engine thrust, is generally needed) as well as cruise (where a lesser amount of total engine thrust, is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 191 may be positioned in thermal communication with the fan duct 172. For example, one or more heat exchangers 191 may be disposed within the fan duct 172 and utilized to cool one or more fluids from the core engine with the air passing through the fan duct 172, as a resource for removing heat from a fluid, e.g., compressor bleed air, oil or fuel. As depicted in the exemplary embodiment the one or more heat exchanger 191 are positioned in an aft portion of the fan duct, and more specifically, the one or more heat exchangers is located in an aft 50% of the fan duct.

It should be appreciated that in alternative exemplary embodiments one or more heat exchangers 191 may define at least a portion of the fan duct. In such a manner the one or more heat exchangers 191 may eliminate the need for additional structure that may define the fan duct 172.

Although not depicted, the heat exchanger 191 may be an annular heat exchanger extending substantially 360 degrees in the fan duct 172 (e.g., at least 300 degrees, such as at least 330 degrees). In such a manner, the heat exchanger 191 may effectively utilize the air passing through the fan duct 172 to cool one or more systems of the engine 100 (e.g., lubrication oil systems, compressor bleed air, electrical components, etc.). The heat exchanger 191 uses the air passing through duct 172 as a heat sink and correspondingly increases the temperature of the air downstream of the heat exchanger 191 and exiting the fan exhaust nozzle 178.

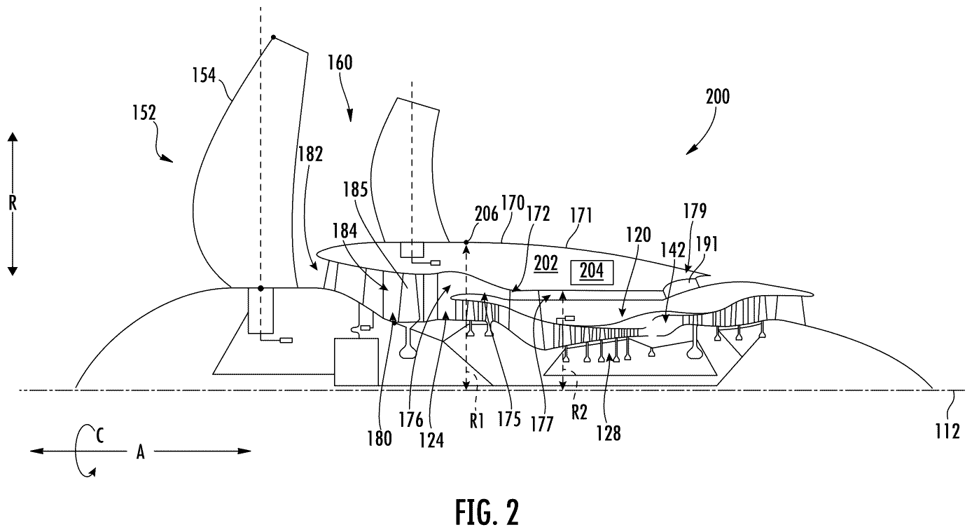

Referring now to FIG. 2, a schematic cross-sectional view of a gas turbine engine 200 is provided according to another example embodiment of the present disclosure. The exemplary gas turbine engine 200 of FIG. 2 may be configured in substantially the same manner as the exemplary gas turbine engine 100 of FIG. 1, and accordingly, the same or similar numbers may refer to the same or similar parts.

For example, the exemplary gas turbine engine of FIG. 2 generally includes a turbomachine 120 defining an engine inlet 182 to an inlet duct 180, a fan duct inlet 176 to a fan duct 172, and a core inlet 124 to a core duct 142. Additionally, the exemplary gas turbine engine 200 generally includes a primary fan, or rather fan 152 having fan blades 154 and a secondary fan or rather ducted fan 184 having fan blades 185.

However, for the embodiment of FIG. 2, a fan cowl 170 is now configured to define an auxiliary space 202 that may have at least one engine accessory 204 mounted within. More particularly, the fan cowl 170 is positioned outward of the fan duct 172 along a radial direction R of the gas turbine engine 200, and the auxiliary space 202 is within the fan cowl 170. As will be appreciated, the auxiliary space 202 is an annular auxiliary space 202 extending substantially 360 degrees within the fan cowl 170 (e.g., at least 300 degrees, such as at least 330 degrees). During an operation condition of the gas turbine engine 200, the radially outward positioning of the auxiliary space 202 may allow the fan duct 172 to attenuate heat transfer from the core engine to the auxiliary space 202. This may allow the auxiliary space 202 to be relatively cooler (e.g., lower temperature) than the core engine. It should be appreciated that the relatively cooler auxiliary space 202 may allow for an increased life expectancy of the at least one engine accessory 204 mounted within the auxiliary space 202.

It should be appreciated that the at least one engine accessory 204 may include but is not limited to valves, electronic accessory systems including engine and system controllers, fire and overheat detection system components, fire extinguisher components, heat exchangers, pumps, generators, etc.

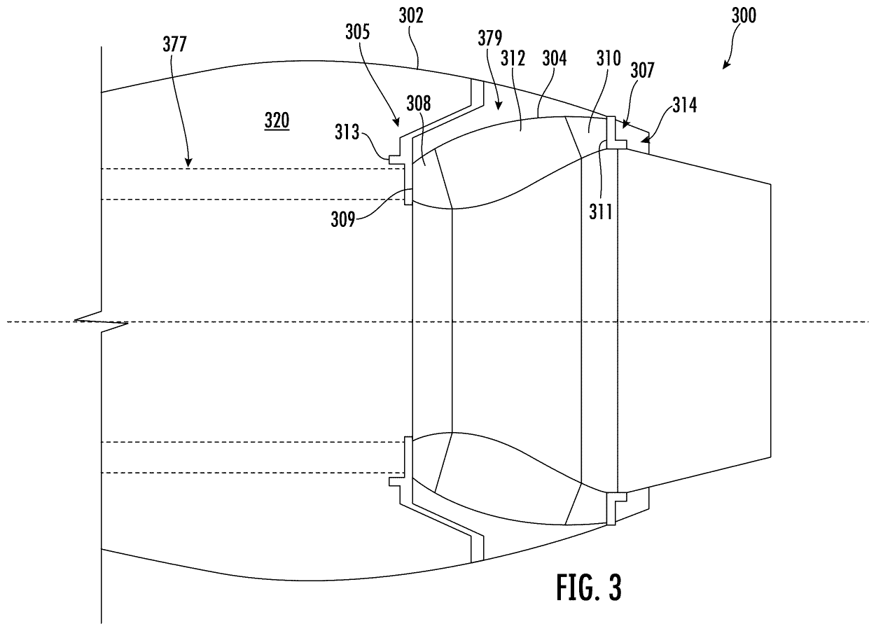

In addition, for the embodiment of FIG. 2, at least a portion of the one or more heat exchangers 191 are now configured to be formed integrally with or coupled to the fan cowl 170. Further, the one or more heat exchangers 191 of the exemplary embodiment define at least a portion of the fan duct 172. More particularly as depicted, the heat exchanger 191 is coupled to an aft portion of the fan cowl 170 such that the heat exchanger 191 defines an aft portion of the fan duct 172. In addition, the heat exchanger 191 may generally include an inlet and an outlet (not depicted in FIG. 2 for clarity; see FIG. 3) that may be formed integrally with or coupled to the fan cowl 170. It should be appreciated that the use of the heat exchanger 191 to define a portion of the fan duct 172 may eliminate the need for additional structure (e.g., a dedicated duct) to define the fan duct 172 at this location.

Further, the fan cowl 170 defines a maximum radius R₁ of the fan cowl 170 from a longitudinal axis 112 to a radially outward most point 206 of the fan cowl 170. It should be appreciated that the radially outward most point 206 of the fan cowl 170 refers to a point on an outer surface of the fan cowl 170 where the radius from the longitudinal axis 112 to the outer surface is the greatest. As depicted, the radially outward most point 206 of the fan cowl 170 is aft of a fan guide vane array 160. In addition, at least a portion of the heat exchanger 191 may be positioned aft of the maximum radius R₁ of the fan cowl 170 and radially inward of the maximum radius R₁ of the fan cowl 170.

It should be appreciated that in alternative exemplary embodiments the radially outward most point 206 may be positioned at any suitable location along the outer surface of the fan cowl 170.

In addition, it will be appreciated that the fan duct 172 includes an inlet portion 175, a forward portion 177, and an aft portion 179. The aft portion 179 is positioned aft of the forward portion 177, and the forward portion 177 is positioned aft of the inlet portion 175. In the embodiment depicted, the forward portion 177 extends over the high pressure compressor 128 of the compressor section of the turbomachine 120. In particular, the forward portion 177 extends along an axial direction A at a location outward of the high pressure compressor 128 along the radial direction R. For the embodiment depicted, the forward portion 177 extends over an entire length of the high pressure compressor 128 and over a portion of the combustion section. Further, for the embodiment depicted, the forward portion 177 of the fan duct is an annular portion of the fan duct 172 that generally extends parallel to the longitudinal axis 112.

In addition, it will be appreciated that the aft portion 179 extends outward along the radial direction R from the forward portion 177, and that the aft portion 179 is formed at least in part by the heat exchanger 191. Such a configuration may allow for an increased volume heat exchanger as compared to a location within the forward portion 177 of the fan duct 172.

Referring still to FIG. 2, the fan duct 172 defines a maximum radius R₂ from longitudinal axis 112 to the forward portion 177 of the fan duct 172. Further it should be appreciated that the maximum radius R₂ of the fan duct 172 is at most 65% of the maximum radius R₁ of the fan cowl 170 (e.g., such as at most 40%, such as at most 55%).

Referring now to FIG. 3, a schematic cross-sectional view of a cowl assembly 300 in accordance with an exemplary aspect of the present disclosure is provided. As is depicted, the cowl assembly 300 generally includes an outer cowl 302 and a heat exchanger 304 coupled to the outer cowl 302. The exemplary cowl assembly 300 may be incorporated into a gas turbine engine such as the gas turbine engines 100 and 200 of FIGS. 1 and 2. More particularly, when incorporated into the gas turbine engine the outer cowl 302 may be configured as a fan cowl (see e.g., fan cowl 170).

The cowl assembly 300 generally defines an annular auxiliary space 320. When incorporated into a gas turbine engine, at least one engine accessory (see e.g., at least one engine accessory 204 of FIG. 2) may be mounted within the auxiliary space 320. It should be appreciated that at least a portion of the heat exchanger 304 may be aft of the auxiliary space 320.

As depicted, the heat exchanger 304 is coupled to the outer cowl 302 of the cowl assembly 300. In addition, the exemplary heat exchanger 304 is an annular heat exchanger that may extend substantially 360 degrees in the outer cowl 302 (e.g., at least 300 degrees, such as at least 330 degrees). The heat exchanger 304 may be a single heat exchanger extending annularly, or may be a plurality of heat exchangers extending annularly, the plurality of heat exchangers spaced along a circumferential direction. Further, the heat exchanger 304 includes an inlet 308, a main body 312, and an outlet 310 in serial flow order.

More specifically, for the embodiment depicted, the cowl assembly 300 further includes a forward bracket 305 and an aft bracket 307. The forward bracket 305 extends inwardly from the outer cowl 302 along a radial direction R and includes a heat exchanger interface 309 coupled to a forward end of the heat exchanger 304, and more specifically coupled to the inlet 308 of the heat exchanger 304. The aft bracket 307 similarly extends inwardly from the outer cowl 302 along the radial direction R and includes a heat exchanger interface 311 coupled to an aft end of the heat exchanger 304, and more specifically coupled to the outlet 310 of the heat exchanger 304. In such a manner, the heat exchanger 304 is coupled to the outer cowl 302.

Notably, the forward bracket 305 further includes a fan duct interface 313 configured to couple with a forward portion 377 of a fan duct (depicted in phantom in FIG. 3). In such a manner, the forward bracket 305 may couple the heat exchanger 304 to the forward portion 377 of the fan duct when assembled.

Further, it will be appreciated that with the exemplary configuration depicted, the heat exchanger 304 forms an aft portion 379 of the fan duct, such that no additional or dedicated ducting structures are required to form the aft portion 379 of the fan duct.

As noted above, during operation of a gas turbine engine, air passing through the forward portion 377 of the fan duct may be relatively cooler (e.g., lower temperature) than one or more fluids utilized in a turbomachine (see e.g., turbomachine 120 of FIG. 1). Thus, the heat exchanger 304 may be utilized to cool one or more fluids from the core engine with the air passing through the fan duct, as a resource for removing heat from a fluid, e.g., a compressor bleed air, oil, or fuel

When incorporated into a gas turbine engine (see, e.g., gas turbine engines 100 and 200 of FIGS. 1 and 2), as noted above, the inlet 308 of the heat exchanger 304 may fluidly couple to the forward portion 377 of the fan duct (depicted in phantom; see, e.g., fan duct 172 of FIGS. 1 and 2). During operation of the gas turbine engine air flowing through the forward portion 377 of the fan duct may be directed or routed into the main body 312 of the heat exchanger 304 through the inlet 308. In such a manner, the main body 312 may use the air passing therethrough to cool one or more systems of the gas turbine engine. Further, during operation, the main body 312 may use the air passing through as a heat sink and correspondingly increase the temperature of the air that is directed or routed into the outlet 310 of the heat exchanger 304. The outlet 310 then directs or routes the air to an exhaust nozzle 314 where it may exit the gas turbine engine.

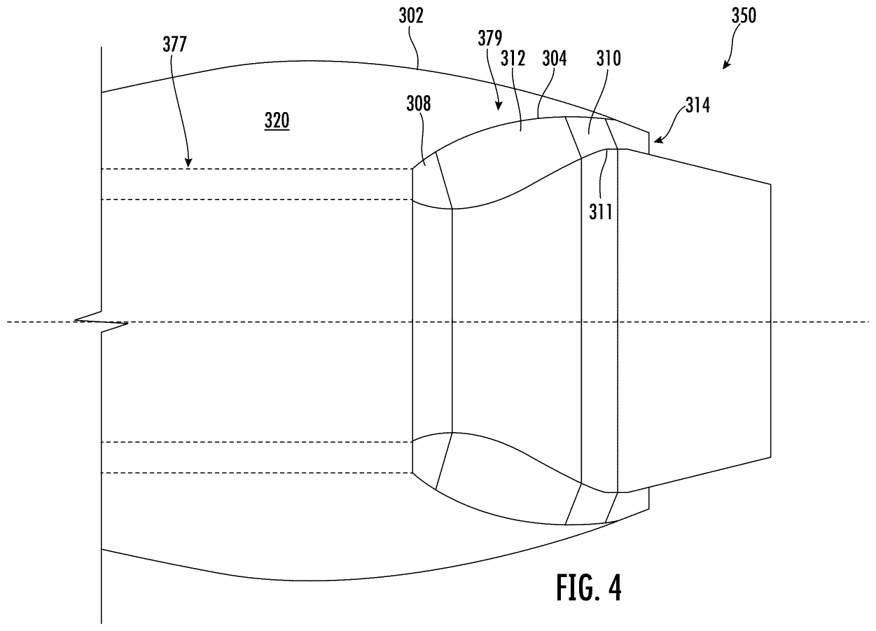

Referring now to FIG. 4, a schematic cross-sectional view of a cowl assembly 350 in accordance with another exemplary aspect of the present disclosure is provided. The exemplary cowl assembly 350 of FIG. 4 may be configured in substantially the same manner as the exemplary cowl assembly 300 of FIG. 3, and accordingly, the same or similar numbers may refer to the same or similar parts.

For example, the exemplary cowl assembly 350 of FIG. 4 generally includes an outer cowl 302 and a heat exchanger 304 that includes an inlet 308, a main body 312, and an outlet 310 in serial flow order. In addition, the exemplary cowl assembly 350 generally defines an annular auxiliary space 320. However, for the embodiment of FIG. 4, the heat exchanger 304 of the cowl assembly 400 is now formed integrally with the outer cowl 302. Further, for the embodiment of FIG. 4, the heat exchanger 304 forms an aft portion 379 of the fan duct, such that no additional or dedicated ducting structures are required to form the aft portion 379 of the fan duct. In addition, it should be appreciated that the inlet 308 of the heat exchanger 304 couples with a forward portion 377 of a fan duct (depicted in phantom in FIG. 3).

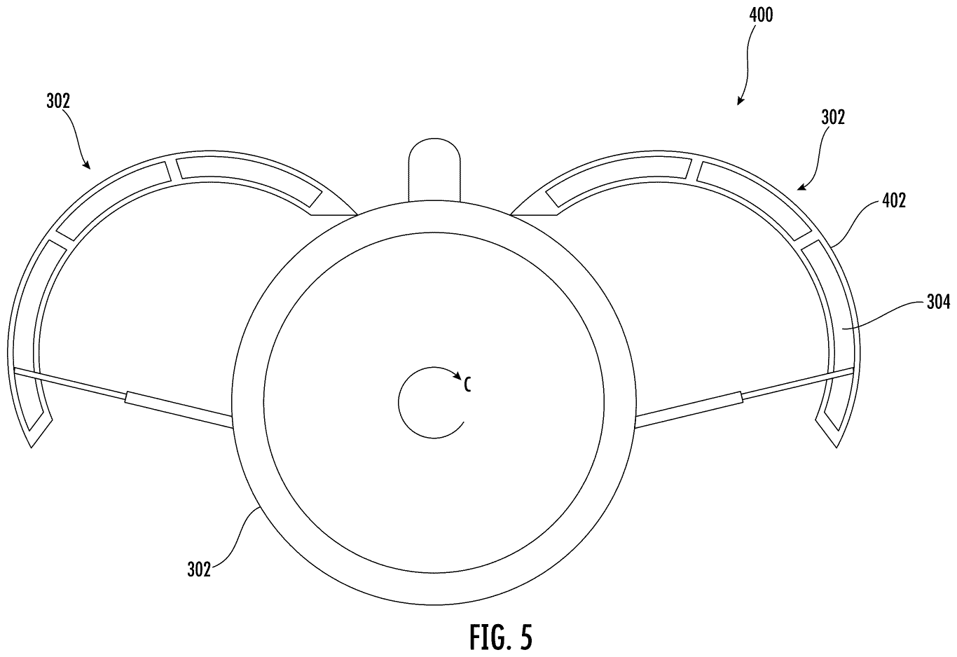

Referring now to FIG. 5, an aft looking forward view of a cowl assembly 400 in accordance with another exemplary aspect of the present disclosure is provided. The exemplary cowl assembly 400 of FIG. 5 may be configured in substantially the same manner as the exemplary cowl assembly 300 of FIG. 3, and accordingly, the same or similar numbers may refer to the same or similar parts.

For example, the exemplary cowl assembly 400 of FIG. 5 generally includes an outer cowl 302. At least a portion of the outer cowl 302 is moveable away from a turbomachine (e.g., turbomachine 120 of FIGS. 1 and 2) during a maintenance operating condition of a gas turbine engine that the exemplary cowl assembly may be incorporated into. It should be appreciated that “moveable away” as used herein refers to the outer cowl 302, or a portion of the outer cowl 302, being moveable relative to a turbomachine of a gas turbine engine during a maintenance operating condition such that a maintenance personnel may access the interior of the outer cowl 302 to repair and maintain the engine. For example, the entirety of the outer cowl 302, including a heat exchanger may be moveable away from the turbomachine during a maintenance operating condition of a gas turbine engine. Additionally, or alternatively, the outer cowl 302 may include one or more outer cowl doors 402 that are moveable away from a turbomachine during a maintenance operating condition of the gas turbine engine.

As depicted, the outer cowl 302 includes one or more outer cowl doors 402 that are moveable away from a turbomachine such that they are moveable between an open position (shown in FIG. 5) and a closed positioned (see, e.g., FIGS. 2 and 3). In addition, for the exemplary embodiment depicted, the cowl assembly 400 includes one or more heat exchanger 304 that are formed integrally with or coupled to the outer cowl 302, and more specifically to the outer cowl doors 402 (e.g., in the same manner shown in FIG. 3). It should be appreciated that the exemplary cowl assembly 400 may be incorporated into a gas turbine engine (see, e.g., gas turbine engines 100 and 200 of FIGS. 1 and 2) such that the outer cowl 302 of the cowl assembly 400 is a fan cowl (see e.g., fan cowl 170 of FIGS. 1 and 2) of the gas turbine engine. Moreover, it should be appreciated that for the embodiment depicted, the one or more heat exchanger 304 includes a plurality of heat exchangers 304 spaced along a circumferential direction. Such a configuration may allow for the plurality of heat exchangers 304 to independently operate with different accessory systems. Alternatively, however, the one or more heat exchangers 304 may include a single, annular heat exchanger.

As depicted, the one or more outer cowl doors 402 are in the open position such as to allow a maintenance personnel to access the interior of the outer cowl 302 to repair and maintain an engine during a maintenance operating condition of the gas turbine engine. During an operating condition of the gas turbine engine, the one or more doors 402 of the cowl assembly 400 may be in the closed position, and more particularly, the one or more heat exchangers 304 may define a portion of a fan duct (see e.g., fan duct 172 of FIGS. 1 and 2).

Further aspects are provided by the subject matter of the following clauses:

A gas turbine engine comprising: a turbomachine comprising a compressor section, a combustion section, and a turbine section arranged in serial flow order, the turbomachine including an inlet duct defining an engine inlet, a fan duct defining a fan duct inlet, and a core duct defining a core duct inlet; a fan cowl disposed circumferentially around the turbomachine; and a heat exchanger defining a portion of the fan duct, at least a portion of the heat exchanger formed integrally with or coupled to the fan cowl.

The gas turbine engine of any preceding clause, wherein the fan cowl defines a maximum radius, wherein the fan duct comprises a forward portion, wherein the forward portion of the fan duct defines a maximum radius, and wherein the maximum radius of the fan duct is at most 65% of the maximum radius of the fan cowl.

The gas turbine engine of any preceding clause, wherein a forward bracket is configured to couple the heat exchanger to the forward portion of the fan duct.

The gas turbine engine of any preceding clause, wherein an aft bracket is configured to couple the heat exchanger to the outer cowl.

The gas turbine engine of any preceding clause, wherein the compressor section comprises a high pressure compressor, and wherein the forward portion extends over the high pressure compressor.

The gas turbine engine of any preceding clause, wherein the heat exchanger is formed integrally with or coupled to an aft portion of the fan cowl.

The gas turbine engine of any preceding clause, wherein at least a portion of the fan cowl is moveable away from the turbomachine during a maintenance operating condition of the gas turbine engine.

The gas turbine engine of any preceding clause, wherein the fan cowl includes one or more fan cowl doors moveable away from the turbomachine during the maintenance operating condition of the gas turbine engine, and wherein the heat exchanger is moveable away from the turbomachine with the one or more fan cowl doors during the maintenance operating condition of the gas turbine engine.

The gas turbine engine of any preceding clause, wherein the fan duct comprises a forward portion and an aft portion, and wherein the heat exchanger forms the aft portion of the fan duct.

The gas turbine engine of any preceding clause, wherein the heat exchanger is located in an aft 50% of the fan duct.

The gas turbine engine of any preceding clause, wherein the compressor section comprises a high pressure compressor, wherein the fan duct comprises a forward portion that extends over the high pressure compressor and an aft portion located aft of the forward portion, and wherein the heat exchanger forms the aft portion of the fan duct.

The gas turbine engine of any preceding clause, wherein the heat exchanger comprises an inlet, a main body, and an outlet, and wherein the inlet and the outlet are formed integrally with or coupled to the fan cowl.

A gas turbine engine comprising: a turbomachine comprising a compressor section, a combustion section, and a turbine section arranged in serial flow order, the turbomachine including an inlet duct defining an engine inlet, a fan duct defining a fan duct inlet, and a core duct defining a core duct inlet; a primary fan driven by the turbomachine; a secondary fan located downstream of the primary fan within the inlet duct; and a heat exchanger located in an aft 50% of the fan duct.

The gas turbine engine of any preceding clause, further comprising: an outer cowl assembly comprising: an outer cowl disposed circumferentially around the turbomachine; wherein the heat exchanger is configured as part of the outer cowl assembly.

The gas turbine engine of any preceding clause, wherein the outer cowl defines a maximum radius, wherein the fan duct comprises a forward portion, wherein the forward portion of the fan duct defines a maximum radius, and wherein the maximum radius of the fan duct is at most 65% of the maximum radius of the outer cowl.

The gas turbine engine of any preceding clause, wherein the heat exchanger is formed integrally with or coupled to an aft portion of the outer cowl.

The gas turbine engine of any preceding clause, wherein at least a portion of the outer cowl is moveable away from the turbomachine during a maintenance operating condition of the gas turbine engine.

The gas turbine engine of any preceding clause, wherein the outer cowl includes one or more outer cowl doors moveable away from the turbomachine during the maintenance operating condition of the gas turbine engine, and wherein the heat exchanger is moveable away from the turbomachine with the one or more outer cowl doors during the maintenance operating condition of the gas turbine engine.

The gas turbine engine of any preceding clause, wherein the heat exchanger comprises an inlet, a main body, and an outlet, and wherein the inlet and the outlet are formed integrally with or coupled to the outer cowl.

The gas turbine engine of any preceding clause, wherein the fan duct comprises a forward portion and an aft portion, and wherein the heat exchanger forms the aft portion of the fan duct.

The gas turbine engine of any preceding clause, wherein the heat exchanger is located in an aft 50% of the fan duct.

The gas turbine engine of any preceding clause, wherein the compressor section comprises a high pressure compressor, wherein the fan duct comprises a forward portion that extends over the high pressure compressor and an aft portion located aft of the forward portion, and wherein the heat exchanger forms the aft portion of the fan duct.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine comprising:
a turbomachine comprising a compressor section, a combustion section, and a turbine section arranged in serial flow order, the turbomachine including an inlet duct defining an engine inlet, a fan duct defining a fan duct inlet, and a core duct defining a core inlet;
a fan cowl disposed circumferentially around the turbomachine; and
a heat exchanger defining a portion of the fan duct, at least a portion of the heat exchanger formed integrally with or coupled to the fan cowl,
wherein the heat exchanger comprises an inlet, a main body, and an outlet, and wherein the inlet and the outlet are formed integrally with or coupled to the fan cowl.

2. The gas turbine engine of claim 1, wherein the fan cowl defines a maximum radius, wherein the fan duct comprises a forward portion, wherein the forward portion of the fan duct defines a maximum radius, and wherein the maximum radius of the fan duct is at most 65% of the maximum radius of the fan cowl.

3. The gas turbine engine of claim 2, wherein the compressor section comprises a high pressure compressor, and wherein the forward portion extends over the high pressure compressor.

4. The gas turbine engine of claim 2, wherein a forward bracket is configured to couple the heat exchanger to the forward portion of the fan duct.

5. The gas turbine engine of claim 1, wherein the heat exchanger is formed integrally with or coupled to an aft portion of the fan cowl.

6. The gas turbine engine of claim 1, wherein at least a portion of the fan cowl is moveable away from the turbomachine during a maintenance operating condition of the gas turbine engine.

7. The gas turbine engine of claim 6, wherein the fan cowl includes one or more fan cowl doors moveable away from the turbomachine during the maintenance operating condition of the gas turbine engine, and wherein the heat exchanger is moveable away from the turbomachine with the one or more fan cowl doors during the maintenance operating condition of the gas turbine engine.

8. The gas turbine engine of claim 1, wherein the fan duct comprises a forward portion and an aft portion, and wherein the heat exchanger forms the aft portion of the fan duct.

9. The gas turbine engine of claim 1, wherein the heat exchanger is located in an aft 50% of the fan duct.

10. The gas turbine engine of claim 1, wherein the compressor section comprises a high pressure compressor, wherein the fan duct comprises a forward portion that extends over the high pressure compressor and an aft portion located aft of the forward portion, and wherein the heat exchanger forms the aft portion of the fan duct.

11. A gas turbine engine comprising:
a turbomachine comprising a compressor section, a combustion section, and a turbine section arranged in serial flow order, the turbomachine including an inlet duct defining an engine inlet, a fan duct defining a fan duct inlet, and a core duct defining a core inlet;
a primary fan driven by the turbomachine;
a secondary fan located downstream of the primary fan within the inlet duct; and
a heat exchanger located in an aft 50% of the fan duct,
wherein the fan duct comprises a forward portion and an aft portion, and wherein the heat exchanger forms the aft portion of the fan duct.

12. The gas turbine engine of claim 11, further comprising:
an outer cowl assembly comprising:
an outer cowl disposed circumferentially around the turbomachine; wherein the heat exchanger is configured as part of the outer cowl assembly.

13. The gas turbine engine of claim 12, wherein the outer cowl defines a maximum radius, wherein the fan duct comprises a forward portion, wherein the forward portion of the fan duct defines a maximum radius, and wherein the maximum radius of the fan duct is at most 65% of the maximum radius of the outer cowl.

14. The gas turbine engine of claim 12, wherein the heat exchanger is formed integrally with or coupled to an aft portion of the outer cowl.

15. The gas turbine engine of claim 12, wherein at least a portion of the outer cowl is moveable away from the turbomachine during a maintenance operating condition of the gas turbine engine.

16. The gas turbine engine of claim 15, wherein the outer cowl includes one or more outer cowl doors moveable away from the turbomachine during the maintenance operating condition of the gas turbine engine, and wherein the heat exchanger is moveable away from the turbomachine with the one or more outer cowl doors during the maintenance operating condition of the gas turbine engine.

17. The gas turbine engine of claim 12, wherein the heat exchanger comprises an inlet, a main body, and an outlet, and wherein the inlet and the outlet are formed integrally with or coupled to the outer cowl.

18. The gas turbine engine of claim 12, further comprising an aft bracket configured to couple the heat exchanger to the outer cowl.

19. The gas turbine engine of claim 11, further comprising a forward bracket configured to couple the heat exchanger to the forward portion of the fan duct.

20. The gas turbine engine of claim 11, wherein the compressor section comprises a high pressure compressor, wherein the fan duct comprises a forward portion that extends over the high pressure compressor and an aft portion located aft of the forward portion, and wherein the heat exchanger forms the aft portion of the fan duct.
